(19) United States
(12) Patent Application Publication
(10) Pub. No.: US 2026/0349874 A1
(43) Pub. Date: Nov. 5, 2026

(54) ENCODER AND FLASH MEMORY CONTROLLER

(71) Applicant: Silicon Motion, Inc., Hsinchu County (TW)

(72) Inventor: Duen-Yih Teng, Hsinchu County (TW)

(73) Assignee: Silicon Motion, Inc., Hsinchu County (TW)

(21) Appl. No.: 19/199,379

(22) Filed: May 5, 2025

(51) Int. Cl. G06F 11/10; G06F 5/01

(52) U.S. Cl. CPC G06F 11/1068; G06F 5/01; G06F 11/1048

(57) ABSTRACT

An encoder includes: a barrel shifter module, a circulant convolution calculation circuit and a compensation circuit. The barrel shifter module is arranged to process multiple data blocks to sequentially generate multiple partial parity blocks. The circulant convolution calculation circuit is coupled to the barrel shifter module and arranged to perform a circulant convolution operation upon the multiple partial parity blocks to generate a plurality of convolution results. The compensation circuit is coupled to the circulant convolution calculation circuit and arranged to perform a compensation operation upon the plurality of convolution results to generate a plurality of parity blocks in a causal manner, wherein the plurality of multiple parity blocks are written into a flash memory.

### BACKGROUND OF THE INVENTION

### 1. Field of the Invention

The present invention relates to flash memory, and more particularly, to an encoder for performing error correction code encoding in flash memory and a related flash memory controller.

### 2. Description of the Prior Art

A typical encoder typically relies on a parity-check matrix for checking whether a parity generated by the encoder is correct. For example, after the encoder encodes data to generate the parity, the data and the parity will be multiplied by the parity-check matrix, to generate a multiplication result. If the multiplication result is equal to “0”, it is determined that the encoding is correct; and if the multiplication result is not equal to “0”, it is determined that the encoding is incorrect. In response to the parity-check matrix, the encoder will rely on a corresponding parity-generation matrix for generating appropriate parity. Under some conditions, however, the parity-generation matrix may not be found out, and the encoder will need to perform multiple matrix multiplication operations, compensation operations, and/or adjustment operations to generate parity that is similar to the parity generated by utilizing the parity-generation matrix, which will increase complexity of the encoder. Specially, the compensation operations are usually non-causal, which will greatly increase hardware cost and circuitry complexity of the encoder.

### SUMMARY OF THE INVENTION

The present invention provides a low-density parity-check (LDPC) encoder architecture that utilizes a tesseract-like parity-check matrix exhibiting a two-stage circulant structure, in which the tesseract-like parity-check matrix is obtained by performing isomorphic transformation on a general quasi-cyclic (QC)-LDPC parity-check matrix. Besides, the tesseract-like parity-check matrix can be decomposed into a hierarchy of first-level and second-level submatrices. In one embodiment, one or more non-zero first-level submatrices are block-circulant matrices composed of the second-level submatrices, wherein each of non-zero second-level submatrices is a circulant permutation matrix. Based on the tesseract-like parity-check matrix, the LDPC encoder divides incoming data into multiple data blocks, generates corresponding partial parity blocks via barrel shifter modules, and then performs circulant convolution operations to derive intermediate results. A compensation circuit is further applied to generate final parity blocks based on the intermediate results.

Specifically, due to structural properties of the tesseract-like parity-check matrix, compensation operation can be implemented as a causal architecture, in which the compensation operation for each intermediate result relies only on one or more previously generated intermediate results. This causality allows the encoder to perform encoding with reduced latency, lower memory requirements, and simplified control logic, compared to conventional non-causal architectures that require all intermediate results to be buffered before compensation.

According to one embodiment, an encoder is provided. The encoder comprises: a first barrel shifter module, a first calculation circuit, an adjustment circuit, a first circulant convolution calculation circuit, a compensation circuit and a second calculation circuit. The first barrel shifter module is arranged to process multiple data blocks to sequentially generate multiple partial parity blocks, wherein the multiple partial parity blocks comprise a first part and a second part, generation time of the first part is earlier than generation time of the second part, and a number of partial parity blocks comprised in the first part is less than a number of partial parity blocks comprised in the second part. The first calculation circuit is coupled to the first barrel shifter module and arranged to generate a first calculation result according to the first part. The adjustment circuit is arranged to adjust the second part of the multiple partial parity blocks according to the first calculation result, to generate an adjusted second part. The first circulant convolution calculation circuit is coupled to the adjustment circuit and arranged to perform a circulant convolution operation upon the adjusted first part, to generate a second part parity block. The compensation circuit is coupled to the first circulant convolution calculation circuit and arranged to perform a compensation operation upon the second part parity block to generate a compensated second part parity block in a causal manner. The second calculation circuit is coupled to the compensation circuit and arranged to generate a first part parity block according to the compensated second part parity block, wherein the first part parity block and the compensated second part parity block act as multiple parity blocks that are generated by the encoder for the multiple data blocks, and the multiple data blocks and the multiple parity blocks are written into a flash memory.

According to one embodiment, an encoder is provided. The encoder comprises: a barrel shifter module, an adjustment circuit, a circulant convolution calculation circuit, a compensation circuit, and a calculation circuit. The barrel shifter module is arranged to process multiple data blocks to generate multiple partial parity blocks, wherein the multiple partial parity blocks comprise a first part and a second part, generation time of the first part is earlier than generation time of the second part, and a number of partial parity blocks comprised in the first part is less than a number of partial parity blocks comprised in the second part. The adjustment circuit is arranged to adjust the second part of the multiple partial parity blocks according to the first part, to generate an adjusted second part. The circulant convolution calculation circuit is coupled to the adjustment circuit and arranged to perform a circulant convolution operation upon the adjusted second part, to generate a second part parity block. The compensation circuit is coupled to the circulant convolution calculation circuit and arranged to perform a compensation operation upon the second part parity block to generate a compensated second part parity block in a causal manner. The calculation circuit is coupled to the compensation circuit and arranged to generate a first part parity block according to the compensated second part parity block, wherein the first part parity block and the compensated second part parity block act as multiple parity blocks that are generated by the encoder for the multiple data blocks, and the multiple data blocks and the multiple parity blocks are written into a flash memory.

According to one embodiment, an encoder is provided. The encoder includes: a barrel shifter module, a circulant convolution calculation circuit and a compensation circuit. The barrel shifter module is arranged to process multiple data blocks to sequentially generate multiple partial parity blocks. The circulant convolution calculation circuit is coupled to the barrel shifter module and arranged to perform a circulant convolution operation upon the multiple partial parity blocks to generate a plurality of convolution results. The compensation circuit is coupled to the circulant convolution calculation circuit and arranged to perform a compensation operation upon the plurality of convolution results to generate a plurality of parity blocks in a causal manner, wherein the plurality of multiple parity blocks are written into a flash memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data storage device and a corresponding memory controller according to an embodiment of the present invention.

FIG. 2 is a diagram illustrating a tesseract-like parity-check matrix according to an embodiment of the present invention.

FIG. 3 is a diagram illustrating a QC-LDPC parity-check matrix according to an embodiment of the present invention.

FIG. 4 is a diagram illustrating a tesseract-like parity-check matrix and a parity-generation matrix.

FIG. 5 is a diagram illustrating an encoder according to a first embodiment of the present invention.

FIG. 6 is a diagram illustrating an encoder according to a second embodiment of the present invention.

FIG. 7 is a diagram illustrating an encoder according to a third embodiment of the present invention.

FIG. 8 is a diagram illustrating an encoder according to a fourth embodiment of the present invention.

FIG. 9 is a diagram illustrating an isomorphic matrix of the tesseract-like parity-check matrix.

FIG. 10 is a diagram illustrating an encoder according to a fifth embodiment of the present invention.

FIG. 11 is a diagram illustrating a decoder according to an embodiment of the present invention.

FIG. 12 is a diagram illustrating a shifting circuit for implementing the barrel shifter according to an embodiment of the present invention.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

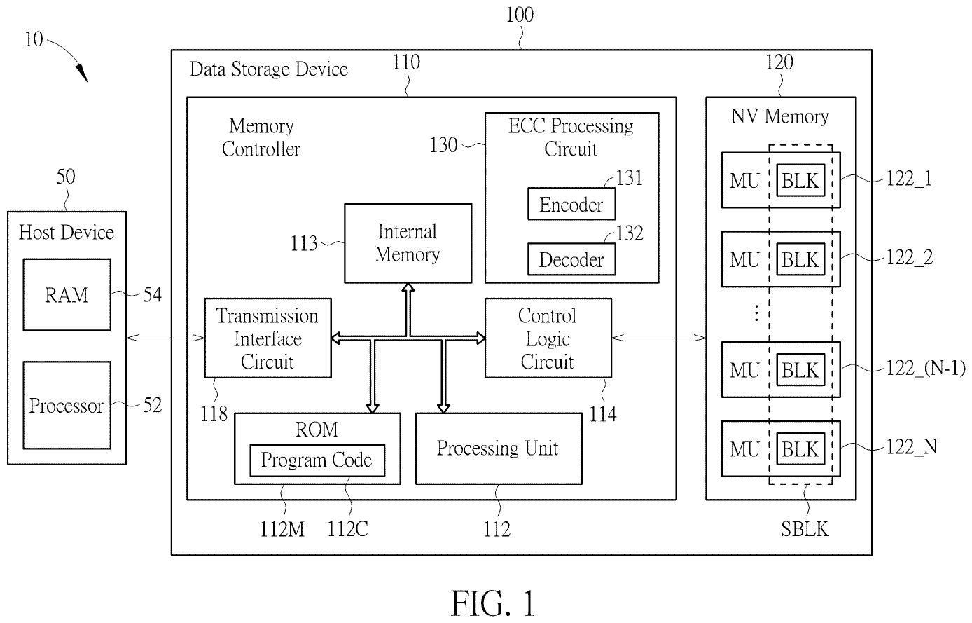

FIG. 1 is a schematic diagram illustrating an electronic device and a data storage device according to one embodiment of the present invention. As illustrated an electronic device 10 comprises a host device 50 and a data storage device 100. The host device 50 may comprise: at least one processor 52 configured to control operations of the host device 50, and a random access memory 54 configured to store data and information required by the processor 52. Examples of the host device 50 may include, but are not limited to: a smartphone, a tablet computer, a wearable device, a personal computer (such as, a desktop computer or a laptop computer), an imaging device (such as, a digital still camera or a video camera), a game console, a car navigation system, a printer, a scanner, or a server system. Examples of the data storage device 100 may include, but are not limited to: a portable memory device (such as a memory card conforming to SD/MMC, CF, MS, XD, or UFS specifications), a solid-state drive (SSD), and various embedded storage devices (such as an embedded storage device conforming to UFS or EMMC specifications).

According to various embodiments, the data storage device 100 may comprise a memory controller 110 and may further comprise a non-volatile (NV) memory 120. The NV memory 120 may comprise one or more NV memory elements, such as a plurality of NV memory elements (MU) 122_1-122_N. For example, the NV memory 120 may be a NAND flash memory, and the NV memory elements 122_1-122_N may be a plurality of NAND flash memory packages or a plurality of NAND flash memory dies, respectively, but the present invention is not limited thereto.

In some embodiments, the NV memory 120 may include a plurality of memory blocks BLK, which may be grouped into a plurality of superblocks SBLK. The memory block BLK may refer to a physical block and includes a plurality of memory cells. The superblock SBLK may be a unit of a logical memory region required for the memory controller 110 to manage the NV memory, where a composition of a superblock SBLK can span across NV memory chips 122_1-122_N. The memory block BLK may be implemented as a memory cell array in which a plurality of memory cells form a two-dimensional (2D) or three-dimensional (3D) array structure. The plurality of memory cells may be single-level cells programmed with one bit or multi-level cells (e.g., double-level cells, triple-level cells or quadruple-level cells) programmed with two bits or more. Moreover, the memory block BLK may include a plurality of pages, where memory cells connected to a same word line may constitute a page. For example, the memory block BLK may be a unit of an erase operation, and the page may be a unit of program and read operations.

In some embodiments, each of NV memory units 122_1-122_N is equipped with control circuitry for executing memory operation commands issued by the memory controller 110. Each of NV memory dies 122_1-122_N may include multiple planes, where each plane may have multiple blocks composed of memory cells, along with associated row and column control circuitry. Through multi-plane operation commands, various memory operations can be applied parallel on different planes to perform multi-plane reading, writing or erasing operations.

The memory controller 110 may comprise a processing unit 112, a read-only memory (ROM) 112M, an internal memory 113, a transmission interface circuit 118, an error checking and correction (ECC) processing circuit 130. At least one portion of these circuits and components may be coupled to one another through a bus. The internal memory 113 can be implemented by one or more RAM devices. For example, the internal memory 113 may comprise a static RAM (SRAM) and/or a dynamic RAM (DRAM). The internal memory 113 could be configured to provide internal storage space for the memory controller 110, for example, temporarily storing information, such as data, addresses, commands, mapping information, and/or variables/parameters. In some embodiments, the memory controller 110 may not include DRAM. Instead, the memory controller 110 may rely on host memory buffer (HMB) technology. With the HMB technology, the memory controller 110 could utilize the RAM 54 (such as DRAM) of the host device 50, as a whole, a part or an extension of the internal memory 113, thereby improving read and write performance of the data storage device 100.

In addition, the ROM 112M in this embodiment is configured to store program code 112C, and the microprocessor 112 is configured to execute the program code 112C, thereby controlling access to the NV memory 120. The program code 112C may include one or more program modules, such as boot loader code. When the data storage device 100 obtains power from the host device 50, the processing unit 112 may execute an initialization process of the data storage device 100 by executing the program code 112C. During the initialization process, the microprocessor 112 may load a set of in-system programming (ISP) codes (not shown in FIG. 1) from the NV memory 120. The microprocessor 112 can execute the ISP codes so that the data storage device 100 can be operable to perform various functions. According to one embodiment of the present invention, the set of ISP codes may include, but are not limited to: one or more program modules associated with memory access (e.g., reading, writing, and erasing), such as, a read operation module, a lookup table module, a wear leveling module, a read refresh module, a read reclaim module, and a garbage collection module, an sudden power-off recovery (SPOR) module, which are provided to perform corresponding reading, lookup table querying, wear leveling, read refreshing, read reclaiming, garbage collection, SPOR and other operations.

The memory controller 110 controls reading, writing, and erasing of the NV memory 120 through a flash control circuit 150. In addition, the memory controller 110 could perform writing of data based on host commands from the host device 50 and writing of valid data which is read from the NV memory 120 by a garbage collection and/or a wear-leveling operation concurrently. The transmission interface circuit 118 may conform to a specific communications specification, such as, Universal Serial Bus (USB) specification, Secure Digital (SD) interface, Ultra High Speed-I (UHS-I) interface, Ultra High Speed-II (UHS-II), CompactFlash (CF) interface, Multimedia card (MMC) interface, embedded Multimedia Card (eMMC) specification, Advanced Technology Attachment (ATA), Serial Advanced Technology Attachment (SATA), Parallel Advanced Technology Attachment (PATA), Peripheral Component Interconnect Express (PCI-E), and Universal Flash Storage (UFS) specification, and may perform communications with the host device 50 according to the specific communications specification.

Typically, the host device 50 may indirectly access the memory device 100, through transmitting host commands and corresponding logic addresses to the memory controller 110. The memory controller 110 receives the host commands and the logic addresses, and translates the host commands to memory operation commands, and further controls the NV memory 120 with the memory operation commands to perform read, program or erase operations upon memory cells or data pages having physical addresses within the NV memory 120.

In one embodiment, the ECC processing circuit 130 comprises an encoder 131 and a decoder 132. Both encoding and decoding operations are based on a parity-check matrix for generating or validating codewords. Specifically, the encoder 131 utilizes a generation matrix derived from the parity-check matrix to encode user data received from the host device 50, and outputs a corresponding codeword to be stored in the NV memory 120. On other hand, the decoder 132 uses the parity-check matrix to verify the integrity of a codeword retrieved from the NV memory 120 and performs bit error correction when necessary. According to various embodiments, the encoder 131 and decoder 132 may be Quasi-Cyclic Low-Density Parity-Check (QC-LDPC) encoder and decoder configured to perform QC-LDPC encoding and decoding.

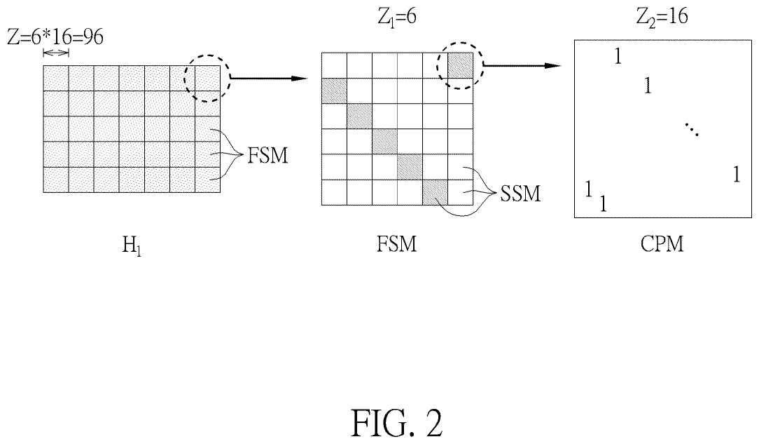

Referring to FIG. 2, a parity-check matrix utilized in the ECC operations of the encoder 131 and decoder 132 may adopt a tesseract-like structure having two-stage circulant characteristics. In the illustrated embodiment, a tesseract-like parity-check matrix H₁ can be decomposed into a 5×7 array of first-level sub-matrices FSM, each being a 96×96 matrix (Z=96). Each of first-level sub-matrices FSM can be further decomposed into a 6×6 array of second-level sub-matrices SSM, where each of second-level sub-matrices SSM is a 16×16 matrix (Z₂=16). Although specific matrix dimensions and decompositions are shown in FIG. 2 for illustrative clarity, the present invention is not limited thereto.

As illustrated by FIG. 2, one or more of the first-level sub-matrices FSM are block-circulant matrices. In a block-circulant first-level sub-matrix FSM, each row or column contains only one non-zero second-level sub-matrix SSM with all the other second-level sub-matrices SSM being zero matrices. Moreover, the non-zero second-level sub-matrix SSM in each row or column is a circulant permutation matrix (CPM). As illustrated, each subsequent row of the block-circulant first-level sub-matrix FSM is a circular shift (e.g., one-position right circular shift) of a previous row, thereby forming a regular cyclic pattern across the whole matrix. In addition, the CPM is a square binary matrix in which each row is a one-position right circular shift of a previous row above it. One CPM contains exactly one element of logical “1” in each row and each column, with all other elements being logical “0”. In view of the above, the tesseract-like parity-check matrix H₁ exhibits a two-stage circulant structure, comprising an outer level of block-wise circulant organization and an inner level of element-wise circulant permutation.

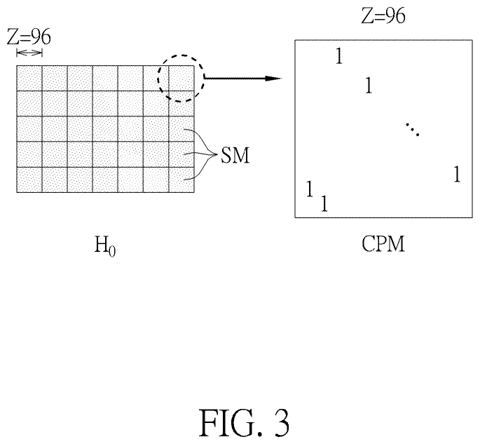

In some embodiments, the tesseract-like parity-check matrix H₁ is isomorphic to a QC-LDPC parity-check matrix H₀. That is, there exists a structural isomorphism between the tesseract-like parity-check matrix H₁ and the general QC-LDPC parity-check matrix H₀, where the isomorphic transformation preserves identical essential error-correction properties while enabling more efficient hardware implementation with reduced complexity. FIG. 3 illustrates a general QC-LDPC parity-check matrix according to one embodiment of the present invention. In the illustrated embodiment, the general QC-LDPC parity-check matrix H₀ can be decomposed into a 5×7 array of sub-matrices SM, each being a 96×96 matrix (Z=96). In addition, one or more of the sub-matrices SM are CPMs. In embodiments of the present invention, the tesseract-like parity-check matrix H₁ can be obtained by performing an isomorphic transformation upon the general QC-LDPC parity-check matrix H₀. Although specific matrix dimensions and decompositions are shown in FIG. 3 for illustrative clarity, the present invention is not limited thereto.

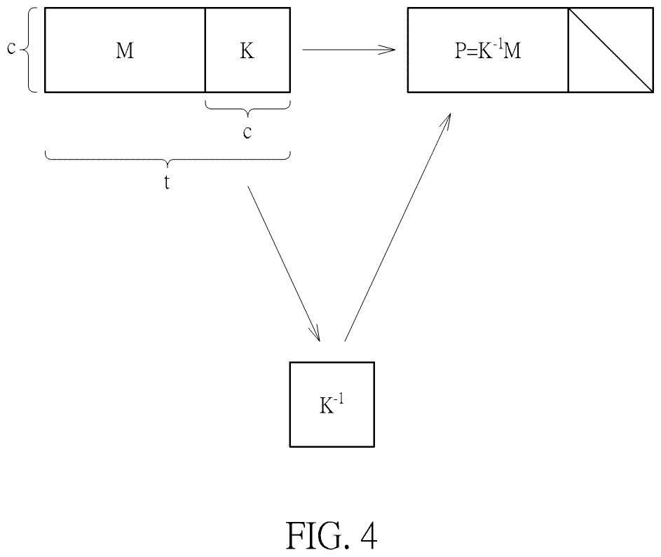

FIG. 4 illustrates principles of implementation of ECC encoding process based on the tesseract-like parity-check matrix H₁. As shown in FIG. 4, it is assumed that tesseract-like parity-check matrix H₁ is a c*t matrix (e.g. c=5 and t=48), and the tesseract-like parity-check matrix H₁ can be divided into a left-side c*(t−c) matrix M and a right-side c*c matrix K. In order to find out a parity-generation matrix corresponding to the tesseract-like parity-check matrix H₁, an inverse matrix K⁻¹ of the matrix K may be found out first. Afterwards, the inverse matrix K⁻¹ is multiplied by the matrix M to generate a matrix P, and a transpose matrix of the matrix P can act as the parity-generation matrix corresponding to the tesseract-like parity-check matrix H₁. In other words, after the transpose matrix of the matrix P is found out, the encoder 131 can multiply input data from the host device 50 by the transpose matrix of the matrix P to obtain the parity of to the input data, and multiply the input data and the generated parity by the tesseract-like parity-check matrix H₁ to determine whether the encoding is correct. For example, if the multiplication result is equal to “0”, it is determined that the encoding is correct; and if the multiplication result is not equal to “0”, it is determined that the encoding is incorrect. After it is determined that the encoding is correct, the input data and the corresponding parity will be written into a page or a super page in the NV memory 120.

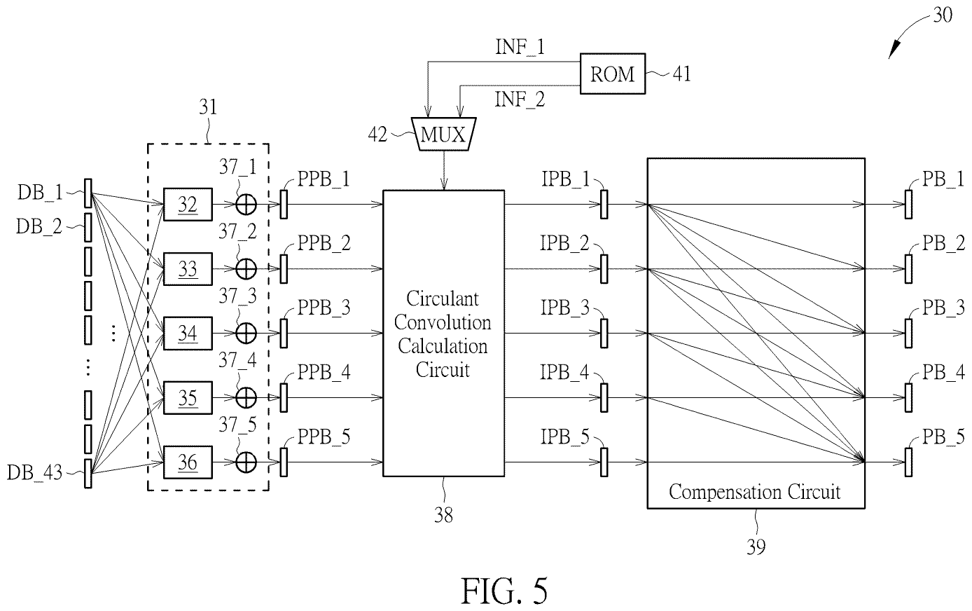

Under some situations, however, the inverse matrix K⁻¹ may not be found out easily. As a result, the encoder 131 will need to perform multiple matrix multiplication operations, compensation operations, and/or adjustment operations to obtain a matrix that is similar to the inverse matrix K⁻¹, for finding out the parity-generation matrix to generate the parity. In view of this, the present invention provides circuit architecture as illustrated by FIG. 5.

As illustrated by FIG. 5, an encoder 30 may include a barrel shifter module 31, a circulant convolution calculation circuit 38, a compensation circuit 39, a ROM 41 and a multiplexer (MUX) 42. In this embodiment, the barrel shifter module 31 may include multiple barrel shifters 32, 33, 34, 35, and 36 and multiple accumulation circuits 37_1-37_5. In addition, the encoder 30 may divide input data from the host device 50 into multiple data blocks (e.g. 43 data blocks DB_1-DB_43 in this embodiment), and encode the 43 data blocks DB_1-DB_43 to generate multiple parity blocks (e.g. parity blocks PB_1-PB_5 in this embodiment). It should be noted that the size of a data block is the same as that of a parity block, and the size of the data block may be determined by designers (e.g. 192*192 bits).

In the operation of the encoder 30, the barrel shifter module 31 may sequentially receive and process the data blocks DB_1-DB_43 to generate multiple partial parity blocks PPB_1-PPB_5. Specifically, the barrel shifter 32 may sequentially perform a shift operation upon the data blocks DB_1-DB_43, and the accumulation circuit 37_1 may sum up 43 shifted data blocks to obtain partial parity block PPB_1. The barrel shifter 33 may sequentially perform a shift operation upon the data blocks DB_1-DB_43, and the accumulation circuit 37_2 may sum up 43 shifted data blocks to obtain partial parity block PPB_2. Similarly, the barrel shifters 34, 35, and 36 may sequentially perform a shift operation upon the data blocks DB_1-DB_43, and the accumulation circuits 37_3, 37_4, and 37_5 may sum up 43 shifted data blocks to obtain partial parity blocks PPB_3, PPB_4, and PPB_5, respectively.

The circulant convolution calculation circuit 38 may perform a circulant convolution operation on each of the partial parity blocks PPB_1-PPB_5 to generate convolution results corresponding to the partial parity blocks PPB_1-PPB_5 (i.e., intermediate parity blocks IPB_1-IPB_5), respectively. Specifically, the circulant convolution calculation circuit 38 may utilize one of circulant convolution calculation auxiliary information INF_1 and INF_2 (through selection of the MUX 42) that is read from the ROM 41, thereby generating the intermediate parity blocks IPB_1-IPB_5 (e.g., convolution results).

The compensation circuit 39 would perform compensation operation on the intermediate parity blocks IPB_1-IPB_5 to generate the parity blocks PB_1-PB_5 if necessary (i.e., the condition where above-mentioned inverse matrix K⁻¹ cannot be found out easily). The compensation circuit 39 would generate the parity blocks PB_1-PB_5 in a causal manner. Specifically, the compensation circuit 39 would perform the compensation operation on a target intermediate parity block based on one or more other intermediate parity blocks IPB_1-IPB_5 that are generated earlier in time than the target intermediate parity block. For example, the compensation circuit 39 performs the compensation operation the intermediate parity block IPB_2 based on the intermediate parity block IPB_1 that is generated earlier in time than the intermediate parity block IPB_2, performs the compensation operation the intermediate parity block IPB_3 based on (at least one of) the intermediate parity blocks IPB_1 and IPB_2 that are generated earlier in time than the intermediate parity block IPB_3, performs the compensation operation the intermediate parity block IPB_4 based on (at least one of) the intermediate parity blocks IPB_1, IPB_2 and IPB_3 that are generated earlier in time than the intermediate parity block IPB_4, and so on.

Advantageously, by transforming a general QC-LDPC parity-check matrix into a tesseract-like parity-check matrix having a two-stage circulant structure, the compensation circuit 39 can be implemented in a causal architecture, in which each compensation operation for a given intermediate result (e.g., intermediate parity block) is performed based only on one or more previously generated intermediate results. As such, the compensation circuit 39 does not require access to future intermediate results, which may eliminate the need to buffer all intermediate results before performing compensation. The causal feature enables the encoder 30 to perform sequential operations, thereby reducing latency, memory usage, and logic complexity compared to conventional non-causal architectures, in which the compensation of the first parity block may require all intermediate results to be available before processing.

It should be noted that the encoding process in the encoder 30 involves many complex mathematical operations. However, since the focus of the present invention is on the design of the circuit architecture, the details of the relevant matrix content and the derivation process are omitted here.

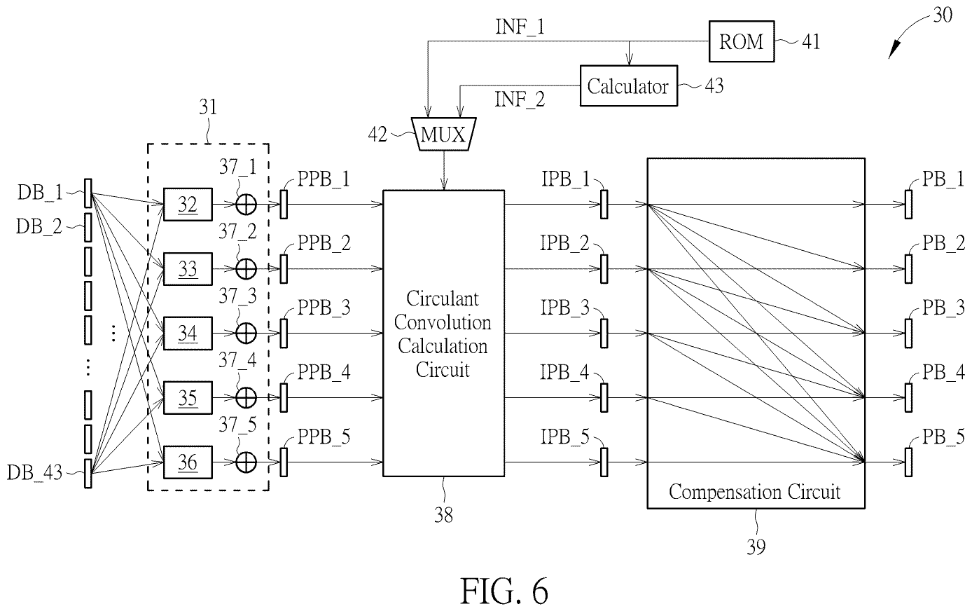

FIG. 6 illustrates another implementation of the encoder 30 according to one embodiment of the present invention. In the embodiment of FIG. 6, the ROM 41 may store only the circulant convolution calculation auxiliary information INF_1, and a calculator 43 could be utilized to generate the circulant convolution calculation auxiliary information INF_2.

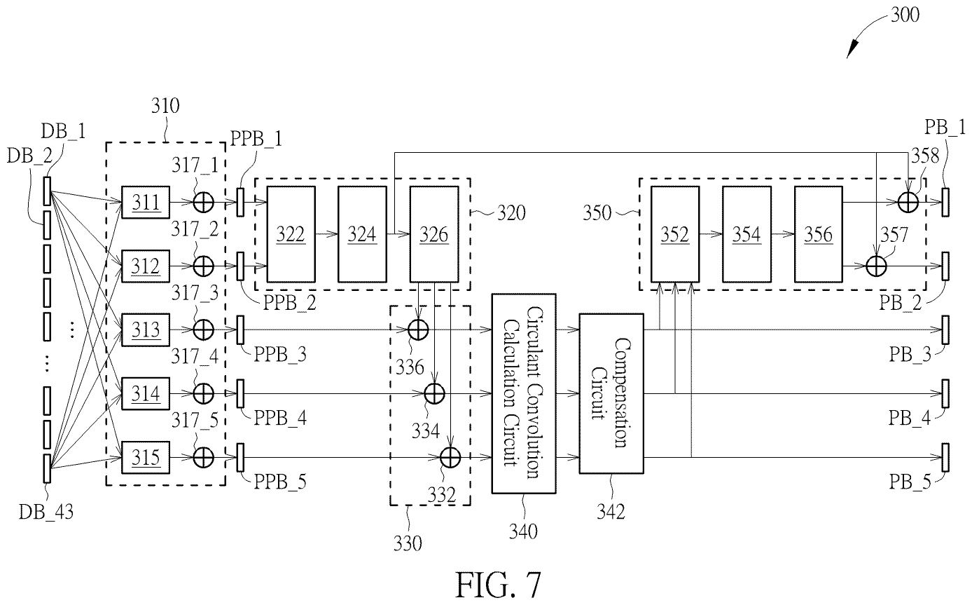

To reduce the computation overhead and circuitry complexity of the circulant convolution calculation circuit and the encoder, the present invention further proposes alternative circuitry architecture of the encoder. Please refer to FIG. 7. FIG. 7 is a diagram illustrating an encoder 300 according to an embodiment of the present invention, wherein the encoder 131 shown in FIG. 1 may be implemented by the encoder 300. As shown in FIG. 7, the encoder 300 may include a barrel shifter module 310, a first calculation circuit 320, an adjustment circuit 330, a circulant convolution calculation circuit 340, a compensation circuit 342, and a second calculation circuit 350. In this embodiment, the barrel shifter module 310 may include multiple barrel shifters 311-315 and multiple accumulation circuits 317_1-317_5. The first calculation circuit 320 may include a circulant convolution calculation circuit 322, a compensation circuit 324, and a barrel shifter module 326. The adjustment circuit 330 may include multiple accumulation circuits 332, 334, and 336. The second calculation circuit 350 may include a barrel shifter module 352, a circulant convolution calculation circuit 354, a compensation circuit 356, and an output circuit that includes 2 accumulation circuits 357 and 358. In this embodiment, the encoder 300 may divide input data from the host device 50 into multiple data blocks (e.g. 43 data blocks DB_1-DB_43 in this embodiment), and encode the 43 data blocks DB_1-DB_43 to generate multiple parity blocks (e.g. parity blocks PB_1-PB_5 in this embodiment). It should be noted that the size of a data block is the same as that of a parity block, and the size of the data block may be determined by designers (e.g. 192*192 bits).

In the operation of the encoder 300, the barrel shifter module 310 may sequentially receive and process the data blocks DB_1-DB_43 to generate multiple partial parity blocks PPB_1-PPB_5. Specifically, the barrel shifter 311 may sequentially perform a shift operation upon the data blocks DB_1-DB_43, and the accumulation circuit 317_1 may sum up 43 shifted data blocks to obtain the partial parity block PPB_1. The barrel shifter 312 may sequentially perform a shift operation upon the data blocks DB_1-DB_43, and the accumulation circuit 317_2 may sum up 43 shifted data blocks to obtain the partial parity block PPB_2. Similarly, the barrel shifters 313, 314, and 315 may sequentially perform a shift operation upon the data blocks DB_1-DB_43, and the accumulation circuits 317_3, 317_4, and 317_5 may sum up 43 shifted data blocks to obtain the partial parity blocks PPB_3, PPB_4, and PPB_5, respectively.

The partial parity blocks PPB_1-PPB_5 may be divided into two parts to undergo different processes, wherein the first part may include 2 partial parity blocks PPB_1 and PPB_2, and the second part may include 3 partial parity blocks PPB_3-PPB_5. In the operation of the first calculation circuit 320, the circulant convolution calculation circuit 322 may perform a circulant convolution operation upon the partial parity blocks PPB_1 and PPB_2, to generate 2 intermediate blocks. The compensation circuit 324 may be an optional component, and may be arranged to compensate the 2 intermediate blocks output by the circulant convolution calculation circuit 322. In one embodiment, the compensation circuit 324 may perform (if necessary) the compensation operation upon the 2 intermediate blocks in a causal manner. For example, the compensation circuit 324 would perform the compensation operation upon the intermediate block corresponding to the partial parity block PPB_2 based on the intermediate block corresponding to the partial parity block PPB_1 (which is generated earlier in time than the partial parity block PPB_2).

The barrel shifter module 326 may be arranged to process the 2 intermediate blocks (compensated by the compensation circuit 324 or not) to generate 2 calculation result blocks. In this embodiment, since the barrel shifter module 326 generates 3 calculation result blocks according to the 2 intermediate blocks, the barrel shifter module 326 may include 6 barrel shifters (2*3=6).

The accumulation circuits 332, 334, and 336 in the adjustment circuit 330 may add the 3 calculation result blocks generated by the barrel shifter module 326 to the second part of the partial parity blocks (i.e. the partial parity blocks PPB_3-PPB_5), to generate multiple adjusted partial parity blocks.

The circulant convolution calculation circuit 340 may perform the circulant convolution operation upon the multiple adjusted partial parity blocks, and generate the parity blocks PB_3-PB_5 through the compensation circuit 342. In one embodiment, the compensation circuit 342 may perform (if necessary) the compensation operation upon results generated by the circulant convolution calculation circuit 340 in a causal manner. For example, the compensation circuit 342 would perform the compensation operation upon the convolution result (that is generated by the circulant convolution calculation circuit 340) corresponding to the partial parity block PPB_4 based on the convolution result corresponding to the partial parity block PPB_3 (which is generated earlier in time than the partial parity block PPB_4), and perform the compensation operation upon the convolution result (that is generated by the circulant convolution calculation circuit 340) corresponding to the partial parity block PPB_5 based on the convolution results corresponding to (at least one of) the partial parity blocks PPB_3 and PPB_4 (which are generated earlier in time than the partial parity block PPB_5).

It should be noted that the compensation circuit 342 may be an optional component. That is, in a situation that compensation is not required, the compensation circuit 342 may be removed from the encoder 300, which will not affect the operation of the encoder 300.

In the operation of the second calculation circuit 350, the barrel shifter module 352 may process the parity blocks PB_3-PB_5 to generate 2 processed blocks. The circulant convolution calculation circuit 354 may perform a circulant convolution operation upon the 2 processed blocks, to generate 2 output blocks. The compensation circuit 356 may be an optional component, and may be arranged to compensate the 2 output blocks output by the circulant convolution calculation circuit 354 in a causal manner. The accumulation circuits 357 and 358 may add the intermediate blocks generated by the circulant convolution calculation circuit 322 or compensated by the compensation circuit 324 to the 2 output blocks generated by the circulant convolution calculation circuit 354 or the compensation circuit 356, respectively, to generate the parity blocks PB_1 and PB_2. In this embodiment, since the barrel shifter module 352 generates the 2 processed blocks according to the 3 parity blocks PB_3-PB_5, the barrel shifter module 352 may include 6 barrel shifters (3*2=6).

After the parity blocks PB_1-PB_5 are generated, the encoder 300 may multiply the data blocks DB_1-DB_43 and the parity blocks PB_1-PB_5 by the parity-check matrix (e.g., the tesseract-like parity-check matrix H₁), to determine whether the parity blocks PB_1-PB_5 are correct. If the parity blocks PB_1-PB_5 are correct, the memory controller 110 may write the data blocks DB_1-DB_43 and the parity blocks PB_1-PB_5 into a page or a super page of a block in the NV memory 120.

In the circuit architecture shown in FIG. 7, the barrel shifter module 310 may match the matrix M shown in FIG. 4, and the first calculation circuit 320, the adjustment circuit 330, the circulant convolution calculation circuit 340, the compensation circuit 342, and the second calculation circuit 350 may be arranged to generate an inverse matrix that is similar to the inverse matrix K⁻¹ shown in FIG. 4. In this way, the parity blocks PB_1-PB_5 can be generated under a situation that the inverse matrix K⁻¹ cannot be found out. In addition, the encoder 300 may have 3 circulant convolution calculation circuits 322, 340, and 354, wherein the circulant convolution calculation circuit 322 performs 2*2 circulant matrix/block multiplications, the circulant convolution calculation circuit 340 performs 3*3 circulant matrix/block multiplications, the circulant convolution calculation circuit 354 performs 2*2 circulant matrix/block multiplications, and the total number of circulant matrix/block multiplications of the encoder 300 is 17 (4+9+4=17). As a result, since the encoder 300 only needs to perform 17 circulant matrix/block multiplication operations to generate 5 parity blocks, which is lower than 25 (5*5) circulant matrix/block multiplications required by the circulant convolution calculation circuit 38 of the encoder 30, the hardware cost and the circuitry complexity of the encoder can be reduced.

In this embodiment, in practice, the encoder 300 sequentially processes the data blocks DB_1-DB_43, and the partial parity blocks PPB_1-PPB_5 are generated sequentially. That is, the generation time of the partial parity blocks PPB_1 and PPB_2 of the first part is earlier than that of the partial parity blocks PPB_3-PPB_5 of the second part. As a result, by setting the number of the partial parity blocks of the first part to be smaller than that of the second part, the execution efficiency of the encoder 300 can be improved. Specifically, by processing the partial parity blocks PPB_1 and PPB_2 of the first part with the earlier generation time through the first calculation circuit 320, the calculation circuit 320 can generate the 3 calculation result blocks earlier for the adjustment circuit 330, which can improve the overall efficiency.

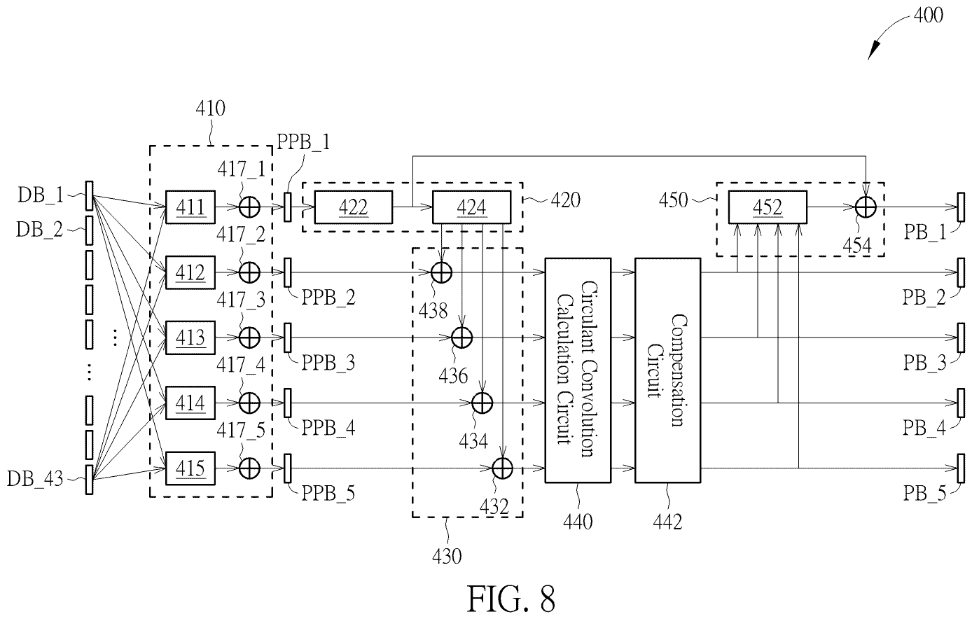

Please refer to FIG. 8. FIG. 8 is a diagram illustrating an encoder 400 according to another embodiment of the present invention, wherein the encoder 131 shown in FIG. 1 may be implemented by the encoder 400. As shown in FIG. 8, the encoder 400 may include a barrel shifter module 410, a first calculation circuit 420, an adjustment circuit 430, a circulant convolution calculation circuit 440, a compensation circuit 442, and a second calculation circuit 450. In this embodiment, the barrel shifter module 410 may include multiple barrel shifters 411-415 and multiple accumulation circuits 417_1-417_5. The first calculation circuit 420 may include 2 barrel shifter modules 422 and 424. The adjustment circuit 430 may include multiple accumulation circuits 432, 434, 436, and 438. The second calculation circuit 450 may include a barrel shifter module 452 and an output circuit 454. The encoder 400 may divide input data from the host device 50 into multiple data blocks (e.g. 43 data blocks DB_1-DB_43), and encode the 43 data blocks DB_1-DB_43 to generate multiple parity blocks (e.g. 5 parity blocks PB_1-PB_5). It should be noted that the size of a data block is the same as that of a parity block, and the size of the data block may be determined by designers (e.g. 192*192 bits).

In the operation of the encoder 400, the barrel shifter module 410 may process the data blocks DB_1-DB_43 to generate multiple partial parity blocks PPB_1-PPB_5. Specifically, the barrel shifter 411 may perform a shift operation upon the data blocks DB_1-DB_43, respectively, and the accumulation circuit 417_1 may sum up 43 shifted data blocks to obtain the partial parity block PPB_1. The barrel shifter 412 may perform a shift operation upon the data blocks DB_1-DB_43, respectively, and the accumulation circuit 417_2 may sum up 43 shifted data blocks to obtain the partial parity block PPB_2. Similarly, the barrel shifters 413, 414, and 415 may perform a shift operation upon the data blocks DB_1-DB_43, and the accumulation circuits 417_3, 417_4, and 417_5 may sum up 43 shifted data blocks to obtain the partial parity blocks PPB_3, PPB_4, and PPB_5, respectively.

The partial parity blocks PPB_1-PPB_5 may be divided into two parts to undergo different processes, wherein the first part may include only one partial parity block PPB_1, and the second part may include 4 partial parity blocks PPB_2-PPB_5. In the operation of the first calculation circuit 420, the barrel shifter module 422 may perform a shift operation upon the partial parity block PPB_1, to generate an intermediate block. The barrel shifter module 424 may process the intermediate block to generate 4 calculation result blocks.

The accumulation circuits 432, 434, 436, and 438 in the adjustment circuit 430 may add the 4 calculation result blocks generated by the barrel shifter module 424 to the partial parity blocks PPB_2-PPB_5, respectively, to generate multiple adjusted partial parity blocks.

The circulant convolution calculation circuit 440 may perform a circulant convolution operation upon the multiple adjusted partial parity blocks, and generate the parity blocks PB_2-PB_5 through the compensation circuit 442. In one embodiment, the compensation circuit 442 would perform the compensation operation upon convolution results generated by the circulant convolution calculation circuit 440 in a causal manner.

For example, the compensation circuit 442 would perform the compensation operation upon the convolution result (that is generated by the circulant convolution calculation circuit 440) corresponding to the partial parity block PPB_3 based on the convolution result corresponding to the partial parity block PPB_2 (which is generated earlier in time than the partial parity block PPB_3), perform the compensation operation upon the convolution result (that is generated by the circulant convolution calculation circuit 440) corresponding to the partial parity block PPB_4 based on (at least of one of) the convolution results corresponding to the partial parity blocks PPB_2 and PPB_3 (which are generated earlier in time than the partial parity block PPB_4), and perform the compensation operation upon the convolution result (that is generated by the circulant convolution calculation circuit 440) corresponding to the partial parity block PPB_5 based on (at least of one of) the convolution results corresponding to the partial parity blocks PPB_2, PPB_3 and PPB_4 (which are generated earlier in time than the partial parity block PPB_5). It should be noted that the compensation circuit 442 may be an optional component. That is, in a situation that compensation is not required, the compensation circuit 442 may be removed from the encoder 400, which will not affect the operation of the encoder 400.

In the operation of the second calculation circuit 450, the barrel shifter module 452 may process the parity blocks PB_1-PB_4 to generate a processed block. The output circuit 454 may add the intermediate block generated by the barrel shifter module 422 to the processed block generated by the barrel shifter module 452, to generate the parity block PB_1.

After the parity blocks PB_1-PB_5 are generated, the encoder 400 may multiply the data blocks DB_1-DB_43 and the parity blocks PB_1-PB_5 by the tesseract-like parity-check matrix H₁, to determine whether the parity blocks PB_1-PB_5 are correct. If the parity blocks PB_1-PB_5 are correct, the memory controller 110 may write the data blocks DB_1-DB_43 and the parity blocks PB_1-PB_5 into a page or a super page in the NV memory 120.

In the circuit architecture shown in FIG. 8, the barrel shifter module 410 may match the matrix M shown in FIG. 4, and the first calculation circuit 420, the adjustment circuit 430, the circulant convolution calculation circuit 440, the compensation circuit 442, and the second calculation circuit 450 may be arranged to generate an inverse matrix that is similar to the inverse matrix K⁻¹ shown in FIG. 4. In this way, the parity blocks PB_1-PB_5 can be generated under a situation that the inverse matrix K⁻¹ cannot be found out. In addition, the encoder 400 may have only one circulant convolution calculation circuit 440, wherein the circulant convolution calculation circuit 440 performs 4*4 circulant matrix/block multiplications, which is lower than the 5*5 circulant matrix/block multiplications required by the encoder 30. As a result, since the encoder 400 only needs to perform 16 circulant matrix/block multiplication operations to generate 5 parity blocks, the hardware cost and the circuitry complexity of the encoder can be effectively reduced.

In this embodiment, in practice, the encoder 400 sequentially processes the data blocks DB_1-DB_43, and the partial parity blocks PPB_1-PPB_5 are generated sequentially. That is, the generation time of the partial parity block PPB_1 of the first part is earlier than that of the partial parity blocks PPB_2-PPB_5 of the second part. As a result, by setting the number of the partial parity blocks of the first part to be smaller than that of the second part, the execution efficiency of the encoder 400 can be improved. Specifically, by processing the partial parity block PPB_1 of the first part with the earlier generation time through the first calculation circuit 420, the calculation circuit 420 can generate the 4 calculation result blocks earlier for the adjustment circuit 430, which can improve the overall efficiency.

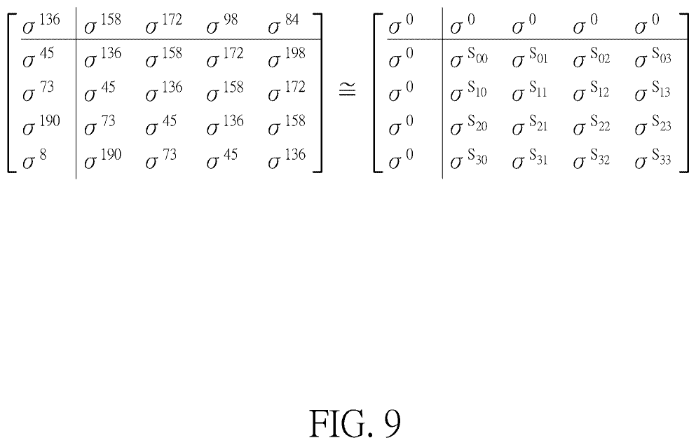

In one embodiment, designers may convert the tesseract-like parity-check matrix H₁ to further generate an isomorphic matrix, so that the circuit architecture of the encoder 131 may be further simplified. Specifically, please refer to FIG. 9. FIG. 9 is a diagram illustrating an isomorphic matrix of the tesseract-like parity-check matrix H₁. As shown in FIG. 9, the left-side matrix is a part of (e.g., the matrix K) of the tesseract-like parity-check matrix H₁, wherein each symbol σ in the left-side matrix is arranged to represent a submatrix, and a superscript of each symbol σ represents how many bits the submatrix is rotated (e.g. “σ¹³⁶” represents the submatrix is rotated by 136 bits). In this embodiment, it is possible to perform conversion to make each of the submatrices of the topmost row and the leftmost column in the whole matrix to become an identity matrix. Specifically, designers may adjust a number of rotated bits of each submatrix in each row according to a number of rotated bits of submatrices in the first column (e.g. a number of rotated bits of each submatrix in the first row is subtracted by “136”), so that each submatrix in the first column of the whole matrix becomes an identity matrix (i.e. “σ⁰”). Afterwards, designers may adjust a number of rotated bits of each submatrix in each column according to a number of rotated bits of a submatrix in the first row (e.g. a number of rotated bits of each submatrix in the second column is subtracted by a number of rotated bits of a submatrix in the first row), so that each submatrix in the first row of the whole matrix becomes an identity matrix (i.e. “σ⁰”). The right-side matrix shown in FIG. 9 is an isomorphic matrix that is generated by converting the part (e.g., the matrix K) of the tesseract-like parity-check matrix H₁, wherein the superscripts S₀₀-S₃₃ indicate numbers of rotated bits of the isomorphic matrix.

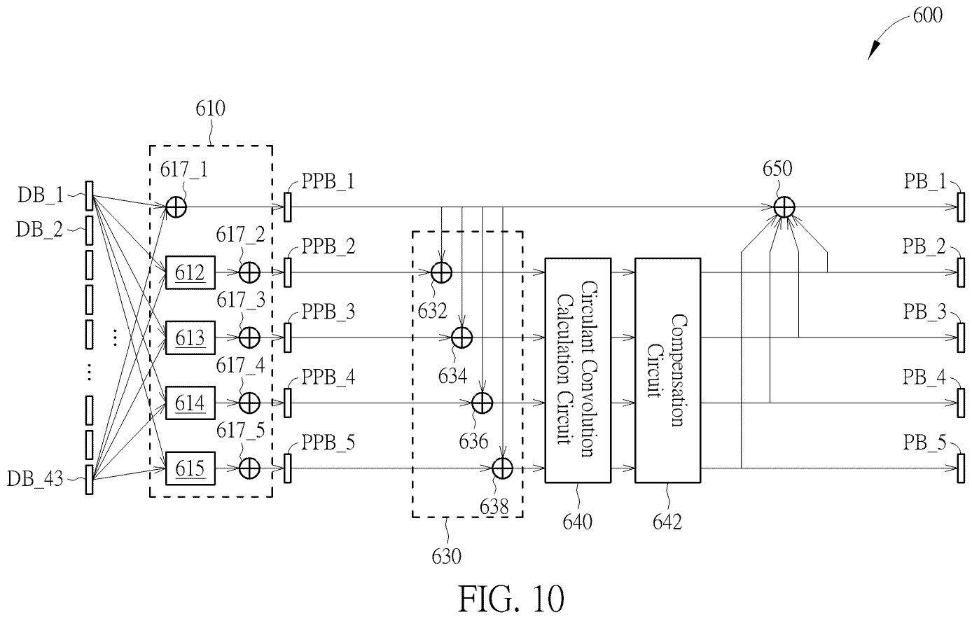

Please refer to FIG. 10. FIG. 10 is a diagram illustrating an encoder 600 according to still another embodiment of the present invention, wherein the encoder 131 shown in FIG. 1 may be implemented by the encoder 600. As shown in FIG. 10, the encoder 600 may include a barrel shifter module 610, an adjustment circuit 630, a circulant convolution calculation circuit 640, a compensation circuit 642, and a calculation circuit 650. In this embodiment, the barrel shifter module 610 may include multiple barrel shifters 612-615 and multiple accumulation circuits 617_1-617_5. The encoder 600 may divide input data from the host device 50 into multiple data blocks (e.g. 43 data blocks DB_1-DB_43), and encode the 43 data blocks DB_1-DB_43 to generate multiple parity blocks (e.g. 5 parity blocks PB_1-PB_5). It should be noted that the size of a data block is the same as that of a parity block, and the size of the data block may be determined by designers (e.g. 192*192 bits).

In the operation of the encoder 600, the barrel shifter module 610 may process the data blocks DB_1-DB_43 to generate multiple partial parity blocks PPB_1-PPB_5. The accumulation circuit 617_1 may directly sum up the data blocks DB_1-DB_43 to generate the partial parity blocks PPB_1. The barrel shifter 612 may perform a shift operation upon the data blocks DB_1-DB_43, respectively, and the accumulation circuit 617_2 may sum up 43 shifted data blocks to obtain the partial parity block PPB_2. Similarly, the barrel shifters 613, 614, and 615 may perform a shift operation upon the data blocks DB_1-DB_43, and the accumulation circuits 617_3, 617_4, and 617_5 may sum up 43 shifted data blocks to obtain the partial parity blocks PPB_3, PPB_4, and PPB_5, respectively.

The partial parity blocks PPB_1-PPB_5 may be divided into two parts to undergo different processes, wherein the first part may include only one partial parity block PPB_1, and the second part may include 4 partial parity blocks PPB_2-PPB_5. The accumulation circuits 632, 634, 636, and 638 in the adjustment circuit 630 may add the partial parity block PPB_1 to the partial parity blocks PPB_2-PPB_5, respectively, to generate multiple adjusted partial parity blocks.

The circulant convolution calculation circuit 640 may perform a circulant convolution operation upon the multiple adjusted partial parity blocks, and generate the parity blocks PB_2-PB_5 through the compensation circuit 642. In one embodiment, the compensation circuit 642 would perform the compensation operation upon convolution results generated by the circulant convolution calculation circuit 640 in a causal manner. For example, the compensation circuit 642 would perform the compensation operation upon the convolution result (that is generated by the circulant convolution calculation circuit 640) corresponding to a target partial parity block based on one or more convolution results corresponding to one or more other partial parity blocks that are generated earlier in time than the target partial parity block. It should be noted that the compensation circuit 642 may be an optional component. That is, in a situation that compensation is not required, the compensation circuit 642 may be removed from the encoder 600, which will not affect the operation of the encoder 600.

The calculation circuit 650 may add the parity blocks PB_2-PB_5 to the partial parity block PPB_1 to, to generate the parity block PB_1. After the parity blocks PB_1-PB_5 are generated, the encoder 600 may multiply the data blocks DB_1-DB_43 and the parity blocks PB_1-PB_5 by the tesseract-like parity-check matrix H₁, to determine whether the parity blocks PB_1-PB_5 are correct. If the parity blocks PB_1-PB_5 are correct, the memory controller 110 may write the data blocks DB_1-DB_43 and the parity blocks PB_1-PB_5 into a page or a super page in the NV memory 120.

In the circuit architecture shown in FIG. 10, the barrel shifter module 610 may match the matrix M shown in FIG. 4, and the adjustment circuit 630, the circulant convolution calculation circuit 640, the compensation circuit 642, and the calculation circuit 650 may be arranged to generate an inverse matrix that is similar to the inverse matrix K⁻¹ shown in FIG. 4. In this way, the parity blocks PB_1-PB_5 can be generated under a situation that the inverse matrix K⁻¹ cannot be found out. In addition, the encoder 600 may have only one circulant convolution calculation circuit 640, wherein the circulant convolution calculation circuit 640 performs 4*4 circulant matrix/block multiplications, which is lower than 5*5 circulant matrix/block multiplications required by the encoder 30. As a result, since the encoder 600 only needs to perform 16 circulant matrix/block multiplication operations to generate 5 parity blocks, the hardware cost and the circuitry complexity of the encoder can be effectively reduced. In addition, compared with the encoder 400 shown in FIG. 8, the encoder 600 does not include the first calculation circuit 420 and some components in the second calculation circuit 450, and the barrel shifter module 610 has one less barrel shifter than the barrel shifter module 410. As a result, the cost and circuitry complexity can be further reduced.

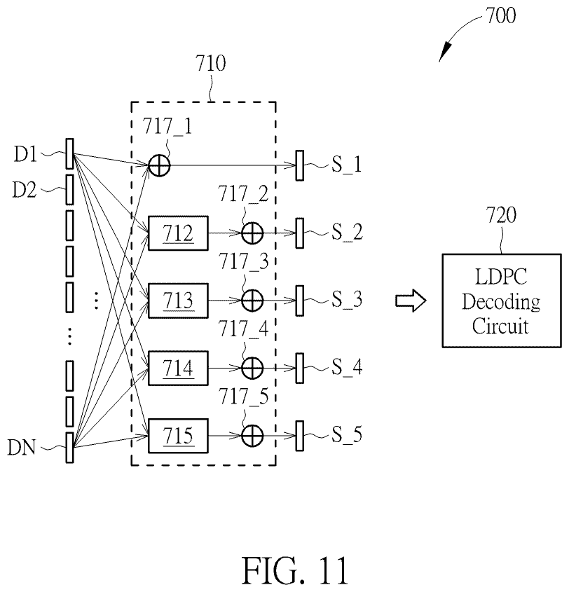

In addition, if the encoder 600 shown in FIG. 10 is adopted, architecture of the decoder 132 can be further simplified to reduce the circuitry complexity. Please refer to FIG. 11. FIG. 11 is a diagram illustrating a decoder 700 according to an embodiment of the present invention, wherein the decoder 132 shown in FIG. 1 may be implemented by the decoder 700. As shown in FIG. 11, the decoder 700 may include multiple barrel shifters 712-715, multiple accumulation circuits 717_1-717_5, and an LDPC decoding circuit 720. In this embodiment, the decoder 700 may be arranged to: receive read data from the NV memory 120; divide the read data into multiple read data blocks D1-DN; perform calculation upon the read data blocks D1-DN to generate multiple decoding syndromes S_1-S_5; and transmit the decoding syndromes S_1-S_5 to the LDPC decoding circuit 720 for decoding, to correct error bits in the read data.

In the operation of the decoder 700, the accumulation circuit 717_1 may directly sum up the read data blocks D1-DN to obtain the decoding syndrome S_1. The barrel shifter 712 may perform a shift operation upon the read data blocks D1-DN, respectively, and the accumulation circuit 717_2 may sum up multiple shifted read data blocks to obtain the decoding syndrome S_2. Similarly, the barrel shifters 713, 714, and 715 may perform a shift operation upon the read data blocks D1-DN, respectively, and the accumulation circuits 717_3, 717_4, and 717_5 may sum up multiple shifted read data blocks to obtain the decoding syndromes S_3-S_5.

In addition, since the process of generating the decoding syndrome S_1 does not need to utilize the barrel shifter, the architecture of the decoder 700 can have fewer components, which results in lower manufacturing cost.

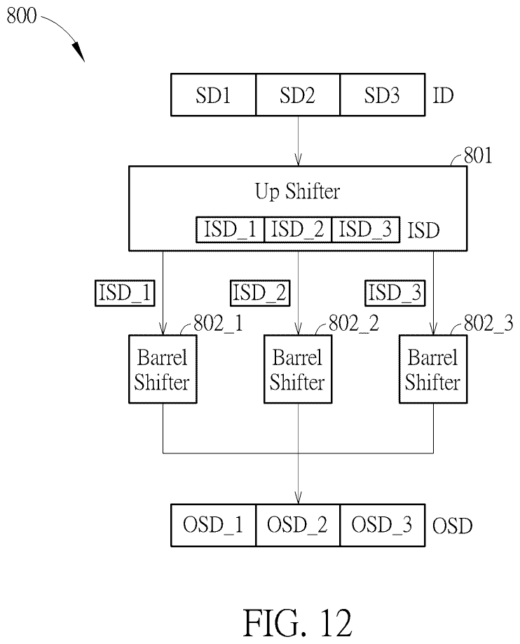

In some embodiments, one or more of the barrel shifters 32-36, 311-315, 411-415, 612-615 and 712-715 may be implemented with hierarchical shifting circuits. Please refer to FIG. 12, which illustrates a schematic diagram of a hierarchical shifting circuit according to one embodiment of the present invention. A shifting circuit 800 illustrated by FIG. 12 can function as one of the barrel shifters 32-36, 311-315, 411-415, 612-615 and 712-715 in the above embodiments, thereby to perform data shift operations associated with computations based on the tesseract-like parity-check matrix H₁ described above.

As illustrated, the shifting circuit 800 comprises an up shifter 801 and a plurality of barrel shifters 802_1-802_3. The number of barrel shifters may vary depending on the design requirements of the encoder 131 or decoder 132, and/or the structure of the tesseract-like parity-check matrix H₁. The up shifter 801 is configured to perform a coarse-grained circular shift operation on input data IND (e.g., one of data blocks DB_1-DB_43) to generate intermediate shifted data ISD. The barrel shifters 802_1-802_3 are configured to respectively receive a respective portion of the intermediate shifted data ISD and perform a fine-grained circular shift operation on the respective portion of the intermediate shifted data ISD, generating a portion of output shifted data.

Specifically, the barrel shifter 802_1 is configured to receive a first portion ISD_1 of the intermediate shifted data ISD and perform the fine-grained circular shift operation on the first portion ISD_1 of the intermediate shifted data ISD to generate a first portion OSD_1 of output shifted data OSD. The barrel shifter 802_2 is configured to receive a second portion ISD_2 of the intermediate shifted data ISD and perform the fine-grained circular shift operation on the second portion ISD_2 of the intermediate shifted data ISD to generate a second portion OSD_2 of output shifted data OSD. The barrel shifter 802_3 is configured to receive a third portion ISD_3 of the intermediate shifted data ISD and perform the fine-grained circular shift operation on the third portion ISD_3 of the intermediate shifted data ISD to generate a third portion OSD_3 of output shifted data OSD.

In addition, the barrel shifters 802_1-802_3 are configured to respectively perform a bit-wise circular shift operation on the respective portions of the intermediate shifted data ISD. For example, the barrel shifter 802_1 is configured to perform a bit-wise circular shift on the first portion ISD_1 of the intermediate shifted data ISD thereby to rotate or circular shift bits within the first portion ISD_1, in a bit-wise manner to generate the first portion OSD_1 of output shifted data OSD. The barrel shifter 802_2 is configured to perform a bit-wise circular shift on the second portion ISD_2 of the intermediate shifted data ISD thereby to rotate or circular shift bits within the second portion ISD_2, in a bit-wise manner to generate the second portion OSD_2 of output shifted data OSD. The barrel shifter 802_3 is configured to perform a bit-wise circular shift on the third portion ISD_3 of the intermediate shifted data ISD thereby to rotate or circular shift bits within the third portion ISD_3, in a bit-wise manner to generate the third portion OSD_3 of output shifted data OSD. Please note that the number of barrel shifters 802_1-802_3 and the number of segments of input data IND mentioned above are just for illustrative purpose rather than the limitation of the present invention.

In conclusion, the present invention provides a tesseract-like parity-check matrix that is isomorphic to a general QC-LDPC parity-check matrix. Such tesseract-like parity-check matrix preserves essential error-correction properties while enabling more efficient hardware implementation with reduced circuitry complexity. That is, due to structural properties of the tesseract-like parity-check matrix, compensation operation can be implemented as a causal architecture. This causality allows the encoder to perform encoding with reduced latency, lower memory requirements, and simplified control logic, compared to conventional non-causal architectures that require all intermediate results to be buffered before compensation.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An encoder, comprising:
a first barrel shifter module, arranged to process multiple data blocks to sequentially generate multiple partial parity blocks, wherein the multiple partial parity blocks comprise a first part and a second part, generation time of the first part is earlier than generation time of the second part, and a number of partial parity blocks comprised in the first part is less than a number of partial parity blocks comprised in the second part;
a first calculation circuit, coupled to the first barrel shifter module, and arranged to generate a first calculation result according to the first part;
an adjustment circuit, arranged to adjust the second part of the multiple partial parity blocks according to the first calculation result, to generate an adjusted second part;
a first circulant convolution calculation circuit, coupled to the adjustment circuit, and arranged to perform a circulant convolution operation upon the adjusted first part, to generate a second part parity block;
a compensation circuit, coupled to the first circulant convolution calculation circuit, arranged to perform a compensation operation upon the second part parity block to generate a compensated second part parity block in a causal manner; and
a second calculation circuit, coupled to the compensation circuit, and arranged to generate a first part parity block according to the compensated second part parity block;
wherein the first part parity block and the compensated second part parity block act as multiple parity blocks that are generated by the encoder for the multiple data blocks, and the multiple data blocks and the multiple parity blocks are written into a flash memory.

2. The encoder of claim 1, wherein the compensation circuit is arranged to perform the compensation operation on a convolution result corresponding to each partial parity block comprised in the second part of the multiple partial parity blocks based on a convolution result corresponding to one or more other partial parity blocks that are generated earlier in time than the partial parity block.

3. The encoder of claim 1, the first part comprises C1 partial parity blocks, the second part comprises C2 partial parity blocks, C1 is smaller than C2, and the first calculation circuit comprises:
a second circulant convolution calculation circuit, arranged to perform a circulant convolution operation upon the C1 partial parity blocks to generate C1 intermediate blocks; and
a second barrel shifter module, coupled to the second circulant convolution calculation circuit, and arranged to process the C1 intermediate blocks to generate C2 calculation result blocks as the first calculation result;
wherein the adjustment circuit adds the C2 calculation result blocks to the C2 partial parity blocks, respectively, to generate the adjusted second part.

4. The encoder of claim 3, wherein the compensated second part parity block comprises C2 compensated parity blocks, and the second calculation circuit comprises:
a third barrel shifter module, arranged to process the C2 compensated parity blocks to generate C1 processed blocks;
a third circulant convolution calculation circuit, coupled to the third barrel shifter module, and arranged to perform a circulant convolution operation upon the C1 processed blocks, to generate C1 output blocks; and
an output circuit, coupled to the third circulant convolution calculation circuit, and arranged to adjust the C1 output blocks according to the C1 intermediate blocks, to generate C1 parity blocks as the first part parity block.

5. The encoder of claim 3, wherein C1 is equal to 2, and C2 is equal to 3.

6. The encoder of claim 5, wherein each of the first calculation circuit and the second calculation circuit comprises a compensation circuit for performing a compensation operation in a casual manner.

7. The encoder of claim 1, wherein the encoder is a low-density parity check (LDPC) code encoding circuit in a flash memory controller.

8. The encoder of claim 1, wherein the encoder is configured to perform LDPC code encoding on the multiple data blocks based on a tesseract-like parity-check matrix that is isomorphic to a quasi-cyclic (QC)-LDPC parity-check matrix.

9. A flash memory controller arranged to control a flash memory comprising the encoder of claim 1.

10. An encoder, comprising:
a barrel shifter module, arranged to process multiple data blocks to generate multiple partial parity blocks, wherein the multiple partial parity blocks comprise a first part and a second part, generation time of the first part is earlier than generation time of the second part, and a number of partial parity blocks comprised in the first part is less than a number of partial parity blocks comprised in the second part;
an adjustment circuit, arranged to adjust the second part of the multiple partial parity blocks according to the first part, to generate an adjusted second part;
a circulant convolution calculation circuit, coupled to the adjustment circuit, and arranged to perform a circulant convolution operation upon the adjusted second part, to generate a second part parity block;
a compensation circuit, coupled to the circulant convolution calculation circuit, arranged to perform a compensation operation upon the second part parity block to generate a compensated second part parity block in a causal manner; and
a calculation circuit, coupled to the compensation circuit, and arranged to generate a first part parity block according to the compensated second part parity block;
wherein the first part parity block and the compensated second part parity block act as multiple parity blocks that are generated by the encoder for the multiple data blocks, and the multiple data blocks and the multiple parity blocks are written into a flash memory.

11. The encoder of claim 10, wherein the compensation circuit is arranged to perform the compensation operation on a convolution result corresponding to each partial parity block comprised in the second part of the multiple partial parity blocks based on a convolution result corresponding to one or more other partial parity blocks that are generated earlier in time than the partial parity block.

12. The encoder of claim 10, wherein the first part comprises only one partial parity block.

13. The encoder of claim 10, wherein the encoder is a low-density parity check (LDPC) code encoding circuit in a flash memory controller.

14. The encoder of claim 10, wherein the encoder is configured to perform LDPC code encoding on the multiple data blocks based on a tesseract-like parity-check matrix that is isomorphic to a quasi-cyclic (QC)-LDPC parity-check matrix.

15. The encoder of claim 10, wherein the encoder is configured to perform LDPC code encoding on the multiple data blocks based on a parity-check matrix, and each submatrix in the first column and the first row of the parity-check matrix is an identity matrix.

16. A flash memory controller arranged to control a flash memory comprising the encoder of claim 10.

17. An encoder, comprising:
a barrel shifter module, arranged to process multiple data blocks to sequentially generate multiple partial parity blocks;
a circulant convolution calculation circuit, coupled to the barrel shifter module, and arranged to perform a circulant convolution operation upon the multiple partial parity blocks to generate a plurality of convolution results; and
a compensation circuit, coupled to the circulant convolution calculation circuit, arranged to perform a compensation operation upon the plurality of convolution results to generate a plurality of parity blocks in a causal manner;
wherein the plurality of data blocks and the plurality of multiple parity blocks are written into a flash memory.

18. The encoder of claim 17, wherein the compensation circuit is arranged to perform the compensation operation on a convolution result corresponding to each partial parity block based on a convolution result corresponding to one or more other partial parity blocks that are generated earlier in time than the partial parity block.

19. The encoder of claim 17, wherein the encoder is configured to perform LDPC code encoding on the multiple data blocks based on a tesseract-like parity-check matrix that is isomorphic to a quasi-cyclic (QC)-LDPC parity-check matrix.

20. A flash memory controller arranged to control a flash memory comprising the encoder of claim 17.
